(19) United States
(12) Patent Application Publication
(10) Pub. No.: US 2016/0004334 A1
(43) Pub. Date: Jan. 7, 2016

(54) Advanced wireless pointing device

(71) Applicant: Miha Abrahamsberg, Ribnica (SI)

(72) Inventor: Miha Abrahamsberg, Ribnica (SI)

(21) Appl. No.: 14/751,165

(22) Filed: Jun. 26, 2015

Related U.S. Application Data
(60) Provisional application No. 62/020,413, filed on Jul. 3, 2014.

(51) Int. Cl. G06F 3/0346; G06F 3/01; G06F 3/038; G06F 3/03

(52) U.S. Cl. CPC G06F 3/0346; G06F 3/0304; G06F 3/014; G06F 3/017; G06F 3/038; G06F 2203/0331

(57) ABSTRACT

Subject of the invention is a method to calculate the point of a display device to which we are pointing to and a device of which one part is a part of a pointing device (like computer mouse or any other electronic pointing device), as part of game controllers or (smart) TV remote controllers. Also a method to calculate the point of the display device to which we are pointing. The device consists of a part that we place to a fixed position relative to the display device (or attached to it or built-in) and a part that can be hand held or worn or built-in another device (game or TV controllers). Both parts have several transceivers (receiver and transmitter) that communicate with each other to ascertain the distance from one to the other. We calculate the distance from the time spent for the signal to get from one transmitter to the other (and back) and the velocity of the signal. For communication, different wave propagations can apply (sound or electromagnetic waves). Knowing the position of all transceivers, we can calculate the point on the display device to which the person is pointing.

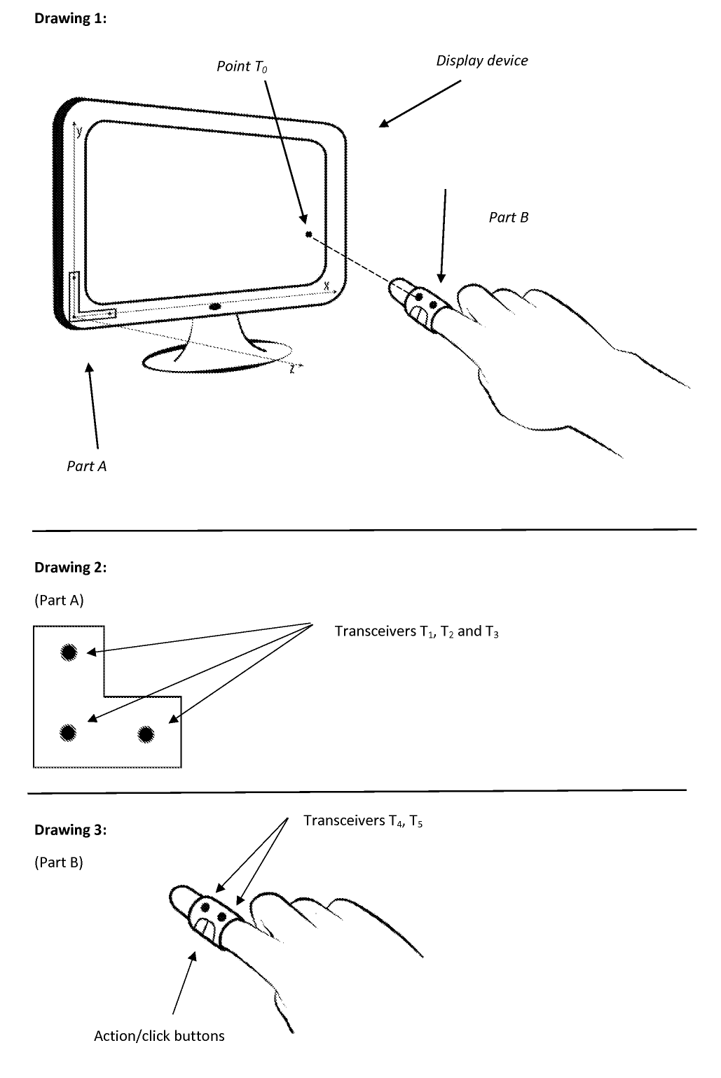

The described technical solution represents a huge leap forward in wireless devices, where it is important to know where the user is pointing the device. There are numerous possible practical applications. For example, a computer mouse which you can hold in your hands and use as normal for presentations, a remote control for so-called Smart TVs (which now have quite slow response and lack of precision), and finally the controls (game pads) for computer games (imagine a controller in the form of a weapon being used in an action game and which “knows” where exactly to point on the display or move its beam of sight).

I would like to claim the benefit of the provisional application No. U.S. 62/020,413, filling date Jul. 03, 2014, applicant: Miha Abrahamsberg

The subject of the invention is a method to calculate the point of a display device to which we are pointing to and a device of which one part is a part of a pointing device (like a computer mouse or any other electronic pointing device), as part of game controllers or (smart) TV remote controllers. The device consists of a part that we place to a fixed position relative to the display device (or attached to it or built-in) and a part that can be hand held or worn. Both parts have several transceivers (receiver and transmitter) that communicate with each other (ping) to ascertain the distance from one to the other. We calculate the distance from the time spent for the signal to get from one transmitter to the other (and back) and the velocity of the signal. For communication, different wave propagations can apply (sound or electromagnetic waves). Knowing the position of all transceivers, we can calculate the point on the display device to which the person is pointing.

In the drawings attached there are three different views presenting one possible practical application of the invention. Drawing 1 depicts a display device with an imaginary coordinate system (X, Y, Z), attached part (part A) to the display device and the other part (part B) worn on a person's finger. The person is using the invention in a manner of a computer mouse. Drawing 2 just shows a more detailed view of the part with three transceivers (the fixed part of the invention) and drawing 3 a more detailed view of the part with two transceivers (the part of the invention that we use, hold or wear).

The invention relates to a method (described below) and a device with transceivers that communicate with each other in order to calculate the distances between them. First part (Part A see Drawing 1) has known 3-dimensional coordinates (in a given 3-dimensional system* of coordinates) of all the transceivers. Based on the calculated distances to transceivers on the other part (Part B see Drawing 1), the coordinates of the transceivers on the latter part are calculated. As a result, we get the position and orientation of part B in a given 3-dimensional system and subsequently the point on the display device.

*a system represents the room or space surrounding the device (invention) and the display device on which it used.

Part A is attached to (or part of) the display device (computer screen, TV, mobile computer screen etc.) and has three transceivers T₁, T₂, T₃ (see Drawing 1 and 2). Distance between T₁ and T₂ is the same as T₂ to T₃. Point T₂ is also the origin of the three dimensional space defined by axes X, Y, Z. Given part A is attached (for example) to the lower left corner of the display device then from the users point of view X increases from left to right, Y increases from bottom to top and Z increases from the display device towards the user (see Drawing 1). We define the coordinates of the transceivers as:

T₁(X₁, Y₁, Z₁)

T₂(X₂, Y₂, Z₂)

T₃(X₃, Y₃, Z₃) [1]

Since T₂ is on the origin of the coordinate system, we can simplify as:

T₁(X₁, 0, 0)

T₂(0, 0, 0)

T₃(0, Y₃, 0) [2]

Part B can be hand held or worn. It has two transceivers T₄ and T₅ and action/click buttons (see drawing 1 and 3). The coordinates of transceivers are unknown:

T₄(X₄, Y₄, Z₄)

T₅(X₅, Y₅, Z₅) [3]

Speed of wave propagation between transceivers (v) depends on the type of wave. For electromagnetic propagation we use the speed of light, for sound we use the speed of sound.

We calculate all the distances between all transceivers on part A (T₁, T₂, T₃) and part B (T₄ and T₅). First distance (d₁₄) is the distance between transceiver T₁ and T₄ and time t₁₄ is the time for the signal to get from T₁ to T₄ and back. The same process is carried out (analogically) for other distances. We calculate all as:

$${d}_{14} = \frac{{t}_{14}}{2} * v \\ {d}_{15} = \frac{{t}_{15}}{2} * v \\ {d}_{24} = \frac{{t}_{24}}{2} * v \\ {d}_{25} = \frac{{t}_{25}}{2} * v \\ {d}_{34} = \frac{{t}_{34}}{2} * v \\ {d}_{35} = \frac{{t}_{35}}{2} * v \qquad [ 4 ]$$

To avoid the problem of reading the same signal more than one time (problem of signals bouncing of an object (walls etc.) in a closed space), we can either assign unique identifications (IDs) to each signal, store the ID when signal is first read and ignore already read IDs or we can (slightly) change the frequency of each signal (frequency rotation), store the frequency information when signal is first read and ignore already read signals, or we can have to consecutive signals, first informing us of which frequency to expect from the “ping” signal and then only read the signal on this frequency once and ignore others (bounced).

Using the formula to calculate distances in 3-D space, we can also define all the above distances as:

d₁₄²=(X₁−X₄)²+(Y₁−Y₄)²+(Z₁−Z₄)²

d₁₅²=(X₁−X₅)²+(Y₁−Y₅)²+(Z₁−Z₅)²

d₂₄²=(X₂−X₄)²+(Y₂−Y₄)²+(Z₂−Z₄)²

d₂₅²=(X₂−X₅)²+(Y₂−Y₅)²+(Z₂−Z₅)²

d₃₄²=(X₃−X₄)²+(Y₃−Y₄)²+(Z₃−Z₄)²

d₃₅²=(X₃−X₅)²+(Y₃−Y₅)²+(Z₃−Z₅)² [5]

The system is significantly simplified when we insert known (predefined) coordinates for points T₁, T₂ and T₃ (see [2] above). We simply get two systems of three equations with three unknown coordinates/variables (X₄, Y₄, Z₄ and X₅, Y₅, Z₅).

d₁₄²=X₄²−2X₄+1+Y₄²+Z₄²

d₂₄²=X₄²+Y₄²+Z₄²

d₃₄²=X₄²+Y₄²−2Y₄+1+Z₄² [6]

### And

d₁₅²=X₅²−2X₅+1+Y₅²+Z₅²

d₂₅²=X₅²+Y₅²+Z₅²

d₃₅²=X₅²+Y₅²−2Y₅+1+Z₅² [7]

From [6] we can now calculate the coordinates of T₄ and for T₅ from [7]:

$${T}_{4} ( {X}_{4} , {Y}_{4} , {Z}_{4} ) = ( \frac{{d}_{24}^{2} - {d}_{14}^{2} + 1}{2} , \frac{{d}_{24}^{2} - {d}_{34}^{2} + 1}{2} , \sqrt{{d}_{24}^{2} - {X}_{4}^{2} - {Y}_{4}^{2}} )$$

$${T}_{5} ( {X}_{5} , {Y}_{5} , {Z}_{5} ) = ( \frac{{d}_{25}^{2} - {d}_{15}^{2} + 1}{2} , \frac{{d}_{25}^{2} - {d}_{35}^{2} + 1}{2} , \sqrt{{d}_{25}^{2} - {X}_{5}^{2} - {Y}_{5}^{2}} )$$

Given that the pointing device should always be in front of the display device (see Drawing 1), we can limit both results (T₄ and T₅) to only positive Z coordinates. This way we only get one solution for both points.

Finally, with both T₄ and T₅ known we have the equation for a line in 3-D space (that Part B projects towards the display device):

$$\frac{X - {X}_{4}}{{X}_{5} - {X}_{4}} = \frac{Y - {Y}_{4}}{{Y}_{5} - {Y}_{4}} = \frac{Z - {Z}_{4}}{{Z}_{5} - {Z}_{4}}$$

Having the display device (its plane in 3-D space) at Z=0 the point (T₀, see drawing 1) on the display device to which the user points is simply:

$$X = - \frac{{Z}_{4}}{{Z}_{5} - {Z}_{4}} ( {X}_{5} - {X}_{4} ) + {X}_{4}$$

$$Y = - \frac{{Z}_{4}}{{Z}_{5} - {Z}_{4}} ( {Y}_{5} - {Y}_{4} ) + {Y}_{4}$$

$$Z = 0$$

Having calculated point T₀ we know exactly to which point on the display device the user is pointing to (note: in practice the computer driver will adjust the calculated point to the actual display resolution and “forward” the information to the operating system).

1. Device to use as a wireless pointing device and a method to calculate the point of the display device to which we are pointing. The device consists of a part that we place to a fixed position relative to the display device (or attached to it or built-in) and a part that can be hand held or worn or built-in into another device. Both parts have several transceivers (receiver and transmitter) that communicate with each other to ascertain the distance from one to the other. The method enables the calculation of the exact point on the display device to which the person is pointing.

2. Device to use as a wireless pointing device as part of game controllers or (smart) TV remote controllers and a method to calculate the point of the display device to which we are pointing. The device consists of a part that we place to a fixed position relative to the display device (or attached to it or built-in) and a part that can be hand held or worn or built-in into another device. Both parts have several transceivers (receiver and transmitter) that communicate with each other to ascertain the distance from one to the other. The method enables the calculation of the exact point on the display device to which the person is pointing.
